(19) United States
(12) Patent Application Publication
(10) Pub. No.: US 2020/0037579 A1
(43) Pub. Date: Feb. 6, 2020

(54) SMART FEEDING APPARATUS WITH SELECTIVE FEED BETWEEN MEAL AND SNACK

(71) Applicant: SaltNLight Inc., Daejeon (KR)

(72) Inventor: Bo Yun EOM, Daejeon (KR)

(73) Assignee: SaltNLight Inc., Daejeon (KR)

(21) Appl. No.: 16/242,909

(22) Filed: Jan. 8, 2019

(30) Foreign Application Priority Data
Aug. 1, 2018 (KR) 10-2018-0089985

(51) Int. Cl. A01K 5/02; A01K 5/01

(52) U.S. Cl. CPC A01K 5/0291; A01K 5/0142

(57) ABSTRACT

The inventive concept relates to a smart feeding apparatus capable of feeding a meal and a snack depending on an input received by the feeding apparatus. In addition, the smart feeding apparatus is capable of adjusting an amount of the meal, selecting a type of the snack, and feeding the selected snack thereby feeding a food in consideration of a condition of a subject to be fed.

### CROSS-REFERENCE TO RELATED APPLICATIONS

A claim for priority under 35 U.S.C. § 119 is made to Korean Patent Application No. 10-2018-0089985 filed On Aug. 1, 2018 in the Korean Intellectual Property Office, the entire contents of which are hereby incorporated by reference.

### BACKGROUND

Embodiments of the inventive concept described herein relate to a remote feeding apparatus, and more particularly, relate to a smart feeding apparatus with selective feed between a meal and a snack.

Since a subject to be fed such as a pet depends on a feeder, the feeder must provide food on a regular basis.

In this connection, the food to be provided may include meal, which is served as a main feed, and a snack. There are two types of feeding apparatuses, one provides the feed at predetermined times, and the other provides the snack prepared in advance. That is, because the feeding apparatus does not provide both the feed and the snack, the subject to be fed may have to eat dry feed only, which doesn't taste good all day long. Otherwise, since only a small amount of the snack may be stored, an amount of feed to be provided over several days may not be stored.

Further, amounts of the meal and the snack to be provided should be adjusted based on a current physical condition of the subject to be fed. However, this may not be taken into consideration at all, and the same amount of the meal and the snack may be repeatedly provided every time, therefore a health of the subject to be fed may be damaged.

### SUMMARY

Embodiments of the inventive concept provide a smart feeding apparatus with selective feed between a meal or a snack, wherein the smart feeding apparatus selectively provides the meal or the snack based on an input received by the feeding apparatus.

Further, embodiments of the inventive concept provide a smart feeding apparatus capable of selectively feeding a meal or a snack, wherein the smart feeding apparatus adjusts an amount of the meal to be provided, selects a type of the snack, and provides the selected snack, based on an input received by the feeding apparatus.

Challenges to be solved by the inventive concept are not limited to those mentioned above, and other challenges not mentioned may be clearly understood by those skilled in the art from the description below.

According to an aspect of an embodiment, a smart feeding apparatus includes a bowl carrier rotatably formed inside a body of the smart feeding apparatus, wherein the bowl carrier is divided into at least two compartments including a meal bowl and a snack bowl, an opening for outwardly exposing a predetermined area of the bowl carrier, a bowl sensor for sensing an identification formed on the bowl carrier, and for determining a position of the bowl, and a control unit, wherein upon receiving either a first input corresponding to a meal feed or a second input corresponding to a snack feed, the control unit is configured to allow the bowl carrier to rotate based on a sensing result from the bowl sensor such that a bowl corresponding to the received input is outwardly exposed through the opening.

According to the inventive concept, the meal and the snack are selectively provided depending on the input received by the feeding apparatus.

Further, the amount of the meal to be provided may be adjusted based on the input received by the feeding apparatus, the type of the snack may be selected, and the selected snack may be provided such that the food may be provided in consideration of a condition of the subject to be fed.

The effects of the inventive concept are not limited to those mentioned above, and other effects not mentioned may be clearly understood by those skilled in the art from the following description.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram of a smart feeding apparatus according to an embodiment of the inventive concept,

FIG. 2 is a front view of a smart feeding apparatus according to an embodiment of the inventive concept,

FIG. 3 is a perspective view of a smart feeding apparatus according to an embodiment of the inventive concept,

FIG. 4 is an exemplary diagram of a bowl carrier according to an embodiment of the inventive concept,

FIG. 5 is an exemplary diagram of an opening and closing part according to an embodiment of the inventive concept,

FIG. 6 is an exemplary diagram illustrating that a meal bowl according to an embodiment of the inventive concept is opened,

FIG. 7 is an exemplary diagram of first snack feed according to an embodiment of the inventive concept,

FIG. 8 is an exemplary diagram of second snack feed according to an embodiment of the inventive concept,

FIG. 9 is an internal perspective view of a smart feeding apparatus according to an embodiment of the inventive concept,

FIG. 10 is an internal perspective view of a smart feeding apparatus, illustrating components installed on a bottom face of a casing according to an embodiment of the inventive concept,

FIG. 11 is a bottom view of a bowl carrier according to an embodiment of the inventive concept, and

### DETAILED DESCRIPTION

The aspects, features and advantages of the inventive concept, and a method for achieving those will become apparent from the following description of the following embodiments given in conjunction with the accompanying drawings. However, the inventive concept is not limited to the embodiments disclosed below, but may be implemented in various forms. The embodiments of the inventive concept are only provided to make the disclosure of the inventive concept complete and fully inform those skilled in the art to which the inventive concept pertains of the scope of the inventive concept. The inventive concept is only defined by scopes of claim.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. The same reference numerals denote like components, “and/or” throughout the specification includes each and every combination of one or more of the components mentioned. In the following description, although the terms “first”, “second”, and the like are used to describe various components, but are not construed to be limited by these terms. These terms are only used to distinguish one component from another. Thus, “a first component” mentioned below may be “a second component” inside the technical sprit of the inventive concept.

Unless otherwise defined, all terms including technical and scientific terms used herein have the same meaning as commonly understood by those skilled in the art to which the inventive concept pertains. It will be further understood that terms, such as those defined in commonly used dictionaries should not be interpreted in an idealized or overly formal sense unless expressly so defined herein.

Hereinafter, embodiments of the inventive concept will be described in detail with reference to the accompanying drawings.

Prior to description, meaning of terms used herein will be briefly described. It should be noted, however, that the description of the terms is intended to assist in understanding the present specification, and thus is not to be construed as limiting the technical idea of the inventive concept unless explicitly stated as limiting the inventive concept.

Herein, a subject to be fed refers to a subject who is provided with food. In addition, the subject to be fed is not limited to a pet. The subject to be fed may include a person (infant, child, etc.). Thus, a smart feeding apparatus according to the present embodiment may be used for the infant as well as the pet.

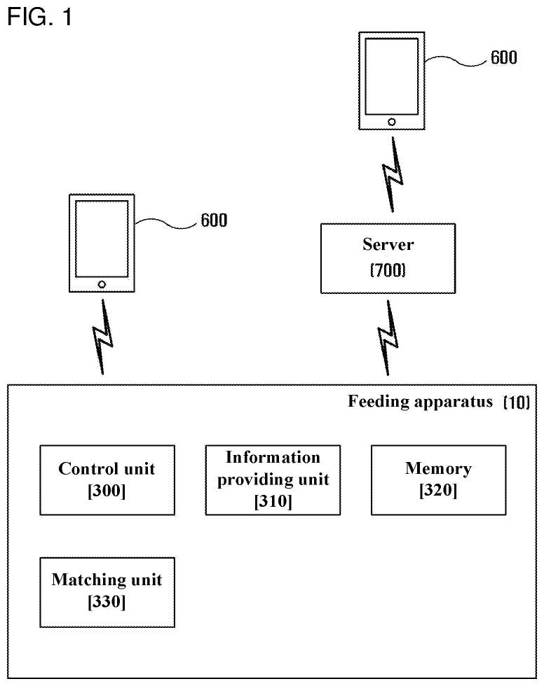

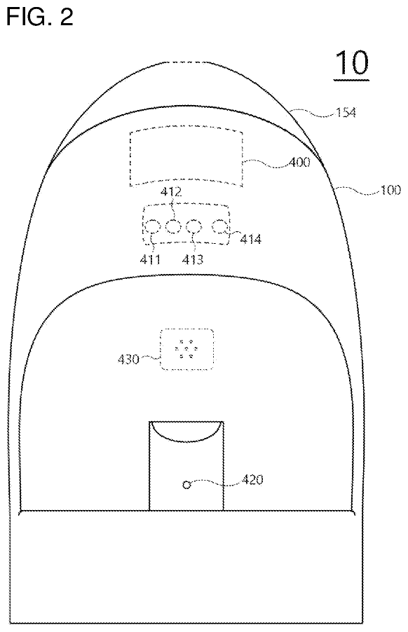

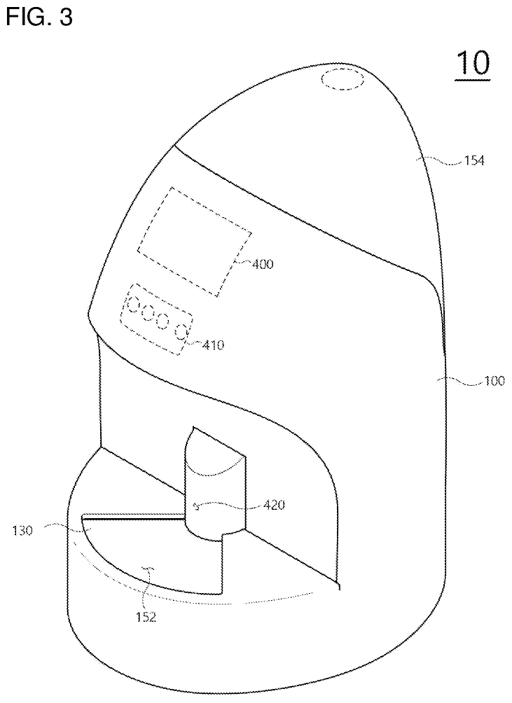

FIG. 1 is a block diagram of a smart feeding apparatus according to an embodiment of the inventive concept. In addition, FIG. 2 to FIG. 10 show a smart feeding apparatus according to an embodiment of the inventive concept.

With reference to FIG. 1 to FIG. 10, a smart feeding apparatus 10 according to an embodiment of the inventive concept includes a casing 100, a bowl carrier 110, an opening and closing part 130, an opening 152, and a control unit 300. In some embodiments, however, the smart feeding apparatus 10 may include a relatively large number of components, or may include a relatively small number of components.

The bowl carrier 110 is rotatably formed at a lower portion inside the casing 100. In addition, the bowl carrier is divided into one or more compartments including a meal bowl 111 and snack bowls 113: 115, 117.

More specifically, the bowl carrier 110 is coupled to a rotary shaft 158 at the lower portion inside the casing 100, and rotates clockwise or counterclockwise depending on an operation of the rotary shaft 158.

The bowl carrier 110 is then divided into two or more compartments, with the meal bowl 111 and the snack bowl 113 being disposed in each compartment.

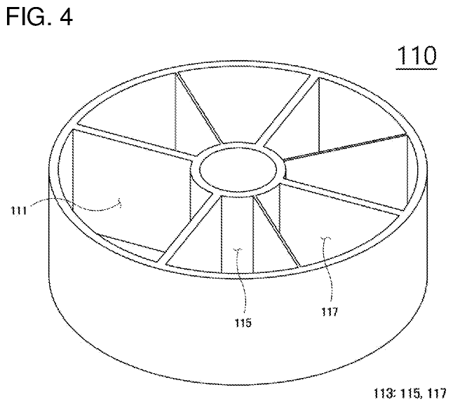

A structure of the bowl carrier 110 will be described with reference to FIG. 4.

With reference to FIG. 4, the bowl carrier 110 is divided into four compartments, with the meal bowl 111 being disposed in a first compartment, and two snack bowls 113 being disposed in each of second to fourth compartments. In this connection, each compartment may correspond to a size or a shape of the opening 152, and the meal bowl 111 may also correspond to the size or the shape of the opening 152. An overall size or a shape of the snack bowl 113 may be similar to those of the meal bowl 111, but the snack bowl 113 may be divided into a plurality of compartments 115 and 117 as required.

This is because a container 140, which will be described below, receives the meal, and delivers the meal into the meal bowl 111, so that only one meal bowl 111 is needed. However, the plurality of snack bowl 113 are needed because the feeder must directly put the snack into the snack bowls. Further, in order to maximize the number of the snack bowls 113 that may be stored in the smart feeding apparatus 10, the size of the snack bowl 113 may be relatively smaller than that of the meal bowl 111. For example, a length of an arc of the snack bowl 113 may be half the length of an arc of the meal bowl 111, but is not limited thereto.

However, this is merely an example of an embodiment of the inventive concept, but the inventive concept is not limited thereto. Thus, the numbers of the meal bowl 111 and the snack bowls 113 are readily selected by a practitioner of the inventive concept.

In this connection, the meal bowl 111 according to the embodiment of the inventive concept refers to a bowl for storing the meal, foodstuff, and meals that the subject to be fed mainly eats, and the snack bowl 113 refers to a bowl for storing the snack of the subject to be fed.

In addition, FIG. 4 illustrates an arrangement of one meal bowl 111 and six snack bowls 113 in the bowl carrier 110. More specifically, the bowl carrier 110 is divided into four compartments, and one meal bowl 111 and two snack bowls 113 may be disposed in each compartment.

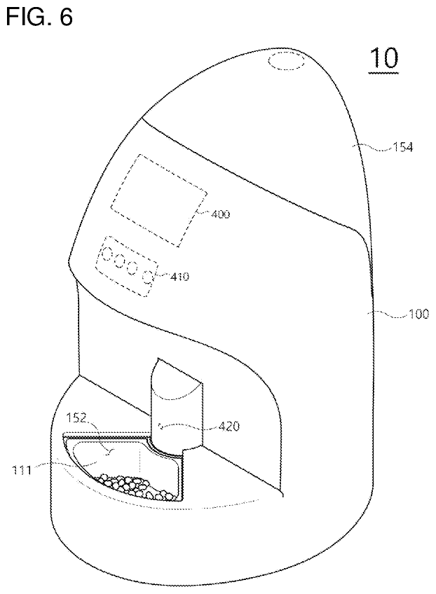

FIG. 4 shows that the bowl carrier 110 is divided into the plurality of compartments, and each of the compartments corresponds to the meal bowl 111 or the snack bowl 113. However, without being limited thereto, as shown in FIG. 6, the separate meal bowl 111 and snack bowl 113 removable from the bowl carrier 110 may be inserted into the bowl carrier 110, or may be removed from the bowl carrier 110. That is, the compartment of the bowl carrier 110 may be defined as an area into which the meal bowl 111 or the snack bowl 113 is to be inserted. Further, the separate meal bowl 111 or snack bowl 113 may be inserted into each area. In this embodiment, the meal bowl 111 and the snack bowl 113 may be removed from the bowl carrier 110, therefore cleaning is convenient.

The opening 152 is formed in the casing 100 so as to upwardly expose a predetermined area of the bowl carrier 110.

More specifically, the opening 152 is configured to allow the meal bowl 111 or the snack bowl 113 disposed in the bowl carrier 110 to be exposed such that the subject to be fed may eat the meal or the snack.

The opening and closing part 130 is rotatably installed at the casing 100, and is located above the bowl carrier 110 to open and close the opening 152.

Without the configuration of the opening and closing part 130, the opening 152 may be always opened, allowing foreign objects such as dust to enter the bowl. Accordingly, the opening and closing part 130 is configured to open the opening 152 only when the subject to be fed is eating.

More specifically, the opening and closing part 130 is also coupled to the rotary shaft 158, but operates separately from the bowl carrier 110. Thus, the opening and closing part 130 is preferably coupled to another rotary shaft which is different from the rotary shaft 158 to which the bowl carrier 110 is coupled.

Upon receiving either a first input corresponding to a meal feed, or a second input corresponding to a snack feed, the control unit 300 is configured to allow the bowl carrier 110 to rotate based on a sensing result from a bowl sensor such that a bowl corresponding to the received input is positioned at the opening 152.

More specifically, upon receiving the first input corresponding to the meal feed, the control unit 300 rotates the bowl carrier 110 so as to locate the meal bowl 111 at a position corresponding to the opening 152, and opens the opening and closing part 130 such that the meal is provided to the subject to be fed.

Further, upon receiving the second input corresponding to the snack feed, the control unit 300 rotates the bowl carrier 110 so as to locate the snack bowl 113 at the position corresponding to the opening 152, and opens the opening and closing part 130 such that the snack is provided to the subject to be fed.

FIG. 6 is an exemplary diagram illustrating that a meal bowl according to an embodiment of the inventive concept is opened. In addition, FIG. 6 illustrates that the meal bowl 111 is located at the opening 152, and the opening and closing part 130 is opened to allow the subject to be fed to eat the meal.

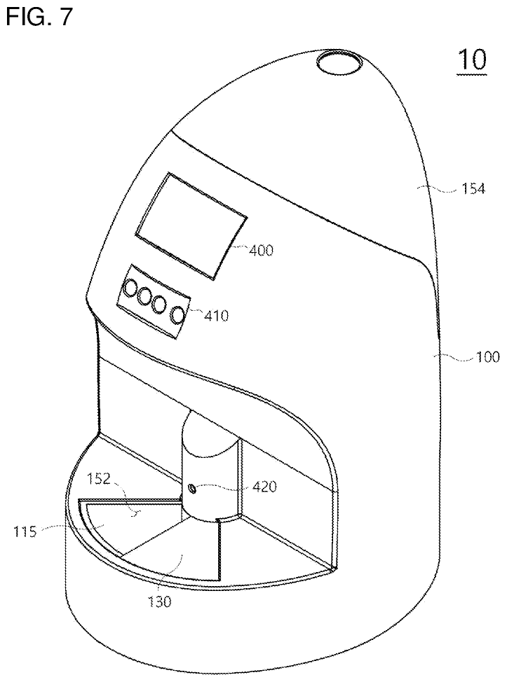

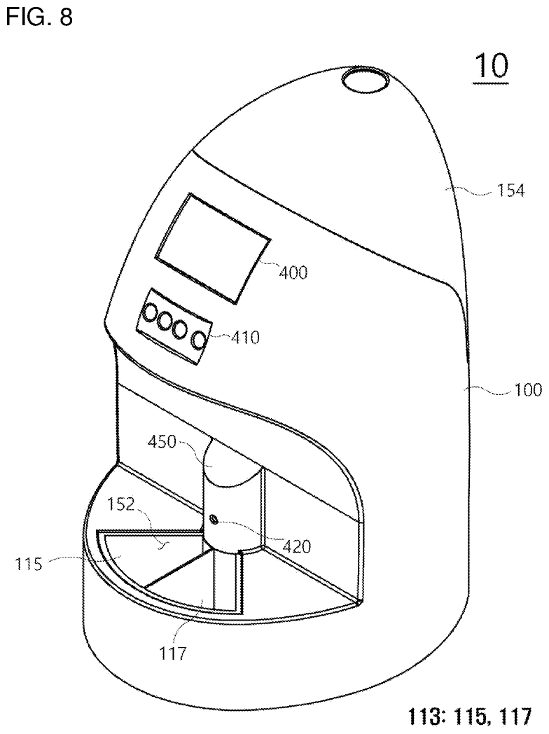

With reference to FIG. 7 and FIG. 8, a detailed example of feeding the snack will be described.

A first snack feed according to an embodiment of the inventive concept is illustrated in FIG. 7, and a second snack feed is illustrated in FIG. 8.

Each snack bowl 113 includes a first snack sub-bowl 115 and a second snack sub-bowl 117.

The control unit 300 is further configured to, upon receiving the second input, perform the first snack feed to allow the bowl carrier 110 to be rotated so as to locate the snack bowl 113 below the opening 152, and to allow the opening and closing part 130 to be opened so as to expose the first snack sub-bowl 115.

Then, the control unit 300 is further configured to, upon receiving the second input again, perform the second snack feed to allow the opening and closing part 130 to be opened so as to expose the second snack sub-bowl 117.

In this connection, when the control unit 300 performs the second snack feed, the control unit 300 may rotate the opening and closing part 130 in the opposite direction such that only the second snack sub-bowl 117 is exposed, or may rotate the opening and closing part 130 in a forward direction such that both the first snack sub-bowl 115 and the second snack sub-bowl 117 are exposed.

In this connection, the main purpose is to provide the snack to the subject to be fed in twice, thus the rotation direction of the opening and closing part 130 may be chosen to suit a design situation.

Further, according to an embodiment of the inventive concept, the bowl carrier 110 has been described above as divided into two or more compartments in which the meal bowl 111 and the snack bowl 113 are disposed.

In this connection, the meal bowl 111 may be disposed in the first compartment, and the different snack bowls 113 may be respectively disposed in the second compartment, the third compartment, and the fourth compartment. Then, different snacks may be stored in the different snack bowls 113.

Therefore, when the second input is received, the snack stored in the snack bowl of the second compartment may be provided, when the third input is received, the snack stored in the snack bowl of the third compartment may be provided, and when the fourth input is received, the snack stored in the snack bowl of the fourth compartment may be provided. In addition, each detailed process of feeding the snack may be the same as described above.

This is a configuration for feeding various types of the snacks to the subject to be fed.

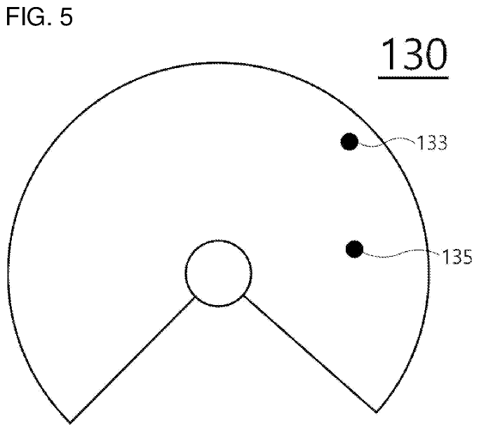

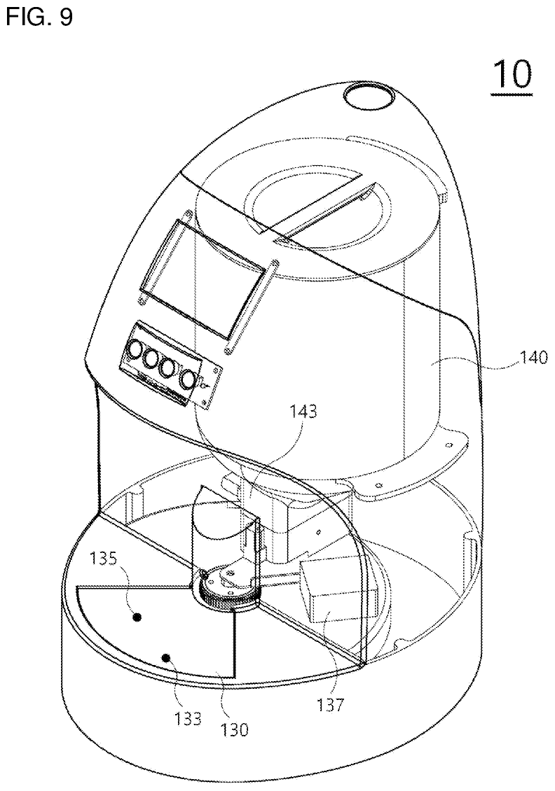

The functions of the first and the second snack feeds are described above, and a configuration for implementing these functions will be described below with reference to FIG. 5 and FIG. 9.

FIG. 5 is an exemplary diagram of the opening and closing part 130 according to an embodiment of the inventive concept, and FIG. 9 is an internal perspective view of the smart feeding apparatus 10 according to an embodiment of the inventive concept.

With reference to FIG. 5, a first top identification 133 and a second top identification 135 are spacedly arranged on a top face of the opening and closing part 130. The opening and closing part 130 may be partially opened and closed via the first and the second top identification 133 and 135 formed on the top face of the opening and closing part 130.

In one example, when performing the first snack feed, the control unit 300 rotates the opening and closing part 130. However, when an opening and closing part sensor 137 provided inside the casing 100 senses the first top identification 133, the control unit 300 stops the rotation of the opening and closing part 130, and opens the opening 152.

At this time, due to the operation, the first snack sub-bowl 115 is outwardly exposed.

Then, when performing the second snack feed, the control unit 300 rotates the opening and closing part 130. However, when the opening and closing part sensor 137 senses the second top identification 135, the control unit 300 stops the rotation of the opening and closing part 130, and opens the opening 152.

At this time, due to the operation, the second snack sub-bowl 117 is outwardly exposed.

That is, the control unit 300 may control whether to expose the first snack sub-bowl 115 only, or both the first and second snack sub-bowls 115 and 117 through the partial opening and closing.

The above examples correspond to one snack bowl 113, but in reality, more top identifications are formed to allow the plurality of snack bowls 113 to be distinguished and exposed.

In addition, any identification that the opening and closing part sensor 137 may sense is applicable as the top identifications. For example, the top identification may be embodied as a perforation of a specific shape in a predetermined area of the opening and closing part 130 or as a mark having a specific shape on a predetermined area of the opening and closing part 130. In this manner, various types of the identifications may be possible.

In addition, the opening and closing part sensor 137 is provided inside the casing 100 as shown in FIG. 9, wherein the opening and closing part sensor 137 is positioned above the opening and closing part 130 to sense the top identifications.

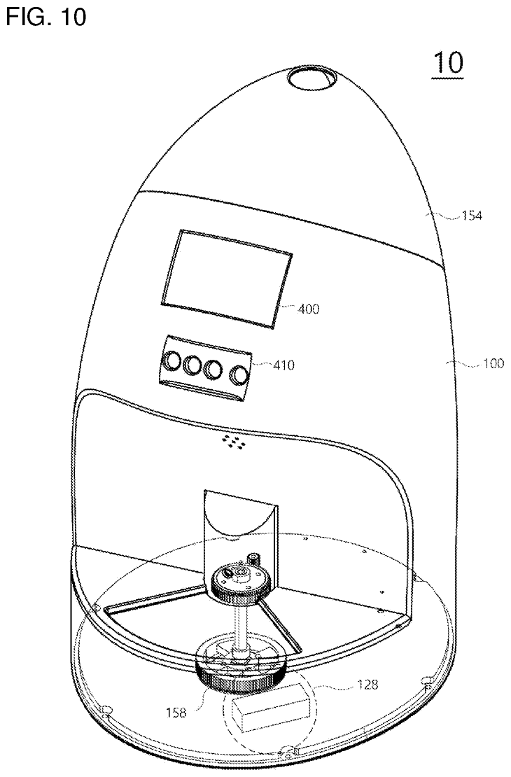

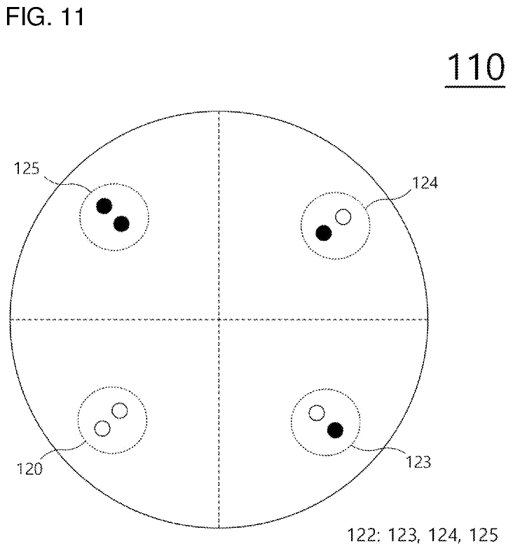

FIG. 10 is an internal perspective view of the smart feeding apparatus 100, illustrating components installed on a bottom face of the casing 100 according to an embodiment of the inventive concept. In addition, FIG. 11 is a bottom view of the bowl carrier according to an embodiment of the inventive concept.

For reference, FIG. 10 is a diagram for illustrating a bowl sensor 128, and illustration of some components is omitted.

A meal bowl identification 120 and a snack bowl identification 122 are spacedly arranged on the bottom face of the bowl carrier 110.

In addition, the bowl sensor 128 for sensing the meal bowl identification 120 and the snack bowl identification 122 is provided at a lower portion inside the body of the carrier.

With this configuration, upon receiving the first input, the control unit 300 rotates the bowl carrier 110. However, when the bowl sensor 128 senses the meal bowl identification 120, the control unit 300 stops the rotation of the bowl carrier 110.

Due to this operation, the meal bowl 111 is positioned at the opening 152.

Then, upon receiving the second input, the control unit 300 rotates the bowl carrier 110. However, when the bowl sensor 128 senses the snack bowl identification 122, the control unit 300 stops the bowl carrier 110.

Due to this operation, the snack bowl 113 is positioned below the opening 152.

Further, when two or more meal bowls 111 and two or more snack bowls 113 exist, different identifications such as the first meal bowl identification 120, the second meal bowl identification 120, the first snack sub-bowl 115 identification, and the second snack sub-bowl 117 identification may be formed for sensing.

As described above, the bowl carrier 110 is divided into the plurality of compartments, and the meal bowl 111 and the snack bowl 113 are placed or inserted into each compartment. Further, the identification for sensing which bowl is disposed in each compartment via the bowl sensor 128 is formed.

Any identification may be implemented as long as the sensor is able to sense the identification, and to distinguish the compartments.

FIG. 11 shows an example of the identification.

FIG. 11 illustrates a ∘∘ identification formed at the first compartment, a ∘● identification formed at the second compartment, a ●∘ identification formed at the third compartment, and a ●● identification formed at the fourth compartment.

As such, the compartments are distinguished with different identifications, and the meal bowl 111 may be disposed in the first compartment. In addition, the first snack sub-bowl 115 and the second snack sub-bowl 117 may be disposed in the second compartment, and the remaining snack bowls may be disposed in the third and fourth compartments.

Thus, the ∘∘ identification may become a meal bowl identification 120, the ∘● identification may become a first snack sub-bowl identification 123, the ●∘ identification may become a second snack sub-bowl identification 124, and the ●● identification may become a third snack bowl identification 125.

The bowl sensor 128 senses such identifications, and senses which bowl is positioned at the current position of the opening 152.

With reference to FIG. 9, the container 140 for receiving the meal, and delivering the meal into the meal bowl 111 is provided at an upper portion of the casing 100.

According to an embodiment of the inventive concept, the feeding apparatus 10 includes the container 140 for receiving the meal, and an outlet 143 for supplying the meal into the meal bowl 111, wherein the outlet 143 is disposed at a lower portion of the feeding apparatus 10.

In this connection, the outlet 143 includes an opening and closing member (unshown), and the opening and closing member is opened or closed based on a rotation of a motor (unshown).

Thus, a period of time during which the opening and closing member is open may be adjusted based on a rotation speed of the motor so that an amount of the meal to be supplied into the meal bowl 111 from the container 140 may be adjusted.

Accordingly, when the first input is received, the control unit 300 rotates the bowl carrier 110 such that the meal bowl 111 is positioned below the outlet 143, then supplies the meal into the meal bowl 111. Thereafter, the control unit 300 controls the speed of the motor provided at the outlet 143 to adjust the opening and closing time of the outlet 143 such that an amount of the meal input by the feeder is supplied.

As another example, the outlet 143 may include a sensor for regulating the amount of the meal to be put.

In addition, the casing 100 includes a casing lid 154. Thus, the feeder may open the casing lid 154, and put the meal into the container 140.

In addition, a weight sensor (unshown) for measuring a weight of the meal bowl 111 may be provided beneath the bowl carrier 110 or the meal bowl 111.

The weight sensor (unshown) may measure a weight of the meal stored in the meal bowl 111 by measuring the weight of the meal bowl 111.

Upon receiving the first input, the control unit 300 is further configured to rotate the bowl carrier 110 so as to position the meal bowl 111 below the outlet 143 of the container 140, and allow the meal to be supplied from the container 140 via the outlet 143 into the meal bowl 111 in an amount input by the feeder.

Further, the control unit 300 provides the meal to the subject to be fed based on a time period input from the feeding apparatus 10 or a feeder terminal 600.

In an embodiment, the meal feeding period and the meal feeding amount may be input from the feeder terminal 600. In addition, the control unit 300 may provide the meal to the subject to be fed based on the input period and the feeding amount.

Further, an amount of the meal input on a one-off basis from the feeder terminal 600, rather than a predetermined supply amount of the meal may be supplied to the subject to be fed.

Upon determining that the subject to be fed of the feeder has finished eating, an information providing unit 310 measures a weight of the meal remaining in the meal bowl 111 using the weight sensor. Then, the information providing unit 310 calculates a weight of the meal consumed by the subject to be fed. Thereafter, the information providing unit 310 provides, to the feeder terminal 600, information on an amount of the consumed food for a certain period based on the information on the calculated weight of the consumed meal.

For example, information on a time and an amount of the meal (meal) for a week or a month may be provided such that the feeder may guess the health status of the subject to be fed based on a change of the amount of the meal consumed by the subject to be fed.

The feeding apparatus 10 according to an embodiment of the inventive concept further includes a speaker 430, a memory 320, a button unit 410, a subject-body temperature measurement sensor 420, and a display 400.

The memory 320 stores a first voice and a second voice input from the feeding apparatus 10 or the feeder terminal 600.

The speaker 430 for outputting sound is installed at the casing 100.

In addition, upon receiving the first input, the control unit 300 outputs the first voice, and provides the meal, and upon receiving the second input, the control unit 300 outputs the second voice, and provides the snack.

For example, after inputting and storing voices such as “A (subject to be fed), it's time for the meal.”, “A (subject to be fed), it's time for the snack.” respectively as the first voice, and the second voice, the first or second voice is output based on the meal feeding or the snack feeding.

As a result, the subject to be fed hears the voice of the feeder, and moves to the feeding apparatus 10.

The button unit 410 is formed on an outer face of the casing 100, and includes a first button 411, a second button 412, a cleaning button 413, and a communication button 414. In addition, a button such as a power button, or the like may be further included.

According to an embodiment of the inventive concept, the first input may be an input from the first button 411, or may be a first signal input from the feeder terminal 600. In addition, the second input may be an input from the second button 412, or may be a second signal input from the feeder terminal 600.

In an embodiment of the inventive concept, the feeding apparatus 10 and the feeder terminal 600 may be paired and connected directly to each other, or may be connected through a server.

Various signals and data may be transmitted and received via an application installed in the feeder terminal 600. In this connection, since the feeder must control the feeding apparatus 10 outside the house as well, it is preferable to connect the feeder terminal 600 and the feeding apparatus 10 through the server to implement this.

The cleaning button 413 is a button to allow the feeder to remove the bowl for cleaning.

Accordingly, when the cleaning button 413 is pressed, the control unit 300 operates the opening and closing part 130 to open the opening 152. In addition, as the cleaning button 413 is pressed one more time, the control unit 300 rotates the bowl carrier 110 by a predetermined angle such that the feeder may remove the different bowls.

In this connection, a bowl naming mark may be formed on a top face of the bowl carrier 110 such that each bowl may be disposed in place after the feeder cleaned each bowl.

For example, identifications such as a “meal bowl”, “first snack sub-bowl”, “second snack sub-bowl”, and the like may be respectively formed on the top face of the bowl carrier 110 where each of the meal bowl 111, the first snack sub-bowl 115, and the second snack sub-bowl 117, and the like should be placed.

In addition, as described above, the button unit 410 according to an embodiment of the inventive concept may further include a third button, and a fourth button in addition to the first button and the second button.

The subject-body temperature measurement sensor 420 is provided on an outer face of the casing 100 to measure the body temperature of the subject to be fed.

More specifically, the subject-body temperature measurement sensor 420 may be provided above the opening 152 to measure the body temperature of the subject to be fed eating the meal or the snack in real time.

The control unit 300 provides information on the body temperature of the subject to be fed measured by the body temperature sensor 420 to the feeder terminal 600. When the body temperature of the subject to be fed deviates from a predetermined range, the control unit 300 transmits a warning message to the feeder terminal 600.

This allows the feeder to recognize that the temperature of the subject to be fed is abnormal, and to take action such as taking the subject to be fed to a hospital for an examination.

In addition, a camera 440 for capturing the subject to be fed may be installed at the casing 100.

Upon receiving a capturing request signal from the feeder terminal 600, the control unit 300 provides a video captured by the camera 440 to the feeder terminal 600 such that the feeder may remotely monitor the subject to be fed.

The communication button 414 may allow the feeding apparatus 10 to be remotedly connected with the server or the feeder terminal 600 using a wired or wireless scheme.

As such, the feeding apparatus 10 is remotely connected via the communication button 414 to transmit and receive the signals and various data.

The display 400 is exposed to the outer face of the casing 100, and may play various videos and video files back.

A broadcast for the subject to be fed (e.g.: a dog TV, a children's TV, a cartoon broadcast, an animation, etc.) may be displayed, a video file transmitted from the feeder terminal 600 may be played back, or a video corresponding to an URL (e.g. Youtube) input by the feeder terminal 600 may be played back.

In addition, an external port may be formed on the outer face of the casing 100, and storage media such as a USB, an external hard disk, and the like may be connected to the external port to play video and image files stored in the storage media back, and output the playback image to the display 400.

The embodiments of the inventive concept have been described above with reference to the accompanying drawings. However, those skilled in the art to which the inventive concept belongs will understand that the inventive concept may be embodied in other specific forms without departing from the spirit or essential features thereof. It is therefore to be understood that the embodiments described above are in all respects illustrative and not restrictive.

What is claimed is:

1. A smart feeding apparatus comprising:
a bowl carrier rotatably formed inside a body of the smart feeding apparatus, wherein the bowl carrier is divided into at least two compartments including a meal bowl and a snack bowl;
an opening for outwardly exposing a predetermined area of the bowl carrier;
a bowl sensor for sensing an identification formed on the bowl carrier, and for determining a position of the bowl; and
a control unit,
wherein upon receiving either a first input corresponding to a meal feed or a second input corresponding to a snack feed, the control unit is configured to allow the bowl carrier to rotate based on a sensing result from the bowl sensor such that a bowl corresponding to the received input is outwardly exposed through the opening.

2. The smart feeding apparatus of claim 1, further comprising an opening and closing part for opening and closing the opening, wherein the opening and closing part is rotatable.

3. The smart feeding apparatus of claim 2, wherein the snack bowl includes a first snack sub-bowl and a second snack sub-bowl,
wherein the control unit is further configured to:
upon receiving the second input, perform a first snack feed to allow the bowl carrier to be rotated so as to locate the snack bowl below the opening, and to allow the opening and closing part to be opened so as to expose the first snack sub-bowl, and
upon receiving the second input again, perform a second snack feed to allow the opening and closing part to be opened so as to expose the second snack sub-bowl.

4. The smart feeding apparatus of claim 3, wherein a first top identification and a second top identification are spacedly arranged on a top face of the opening and closing part,
wherein the control unit is further configured to:
when performing the first snack feed, rotate the opening and closing part, stop the rotation of the opening and closing part when an opening and closing part sensor provided inside a body of the smart feeding apparatus senses the first top identification, and open the opening; and
when performing the second snack feed, rotate the opening and closing part, stop the rotation of the opening and closing part when the opening and closing part sensor senses the second top identification, and open the opening.

5. The smart feeding apparatus of claim 3, wherein a meal bowl identification and a snack bowl identification are spacedly arranged on a bottom face of the bowl carrier,
wherein the control unit is further configured to:
upon receiving the first input, rotate the bowl carrier, and stop the rotation of the bowl carrier when the bowl sensor provided inside the body of the smart feeding apparatus senses the meal bowl identification; and
wherein upon receiving the second input, rotate the bowl carrier, and stop the rotation of the bowl carrier when the bowl sensor senses the snack bowl identification.

6. The smart feeding apparatus of claim 1, further comprising:
a container for receiving the meal; and
an outlet formed below the container for supplying the meal into the meal bowl,
wherein upon receiving the first input, the control unit is further configured to rotate the bowl carrier so as to position the meal bowl below the outlet, and allow the meal to be supplied from the container via the outlet into the meal bowl,
wherein the control unit is further configured to control a speed of a motor provided at the outlet to adjust an opening and closing time of the outlet so as to allow the meal to be supplied into the meal bowl, based on a meal amount input from a feeder.

7. The smart feeding apparatus of claim 6, further comprising:
a weight sensor disposed beneath the bowl carrier or the meal bowl for measuring a weight of the meal bowl; and
an information providing unit,
wherein upon determining that a subject to be fed has finished eating,
the information providing unit is configured to:
measure a weight of the meal remaining in the meal bowl using the weight sensor,
calculate a weight of the meal consumed by the subject to be fed, and
provide, to a feeder terminal, information on an amount of the consumed food for a predetermined period based on the information on the calculated weight of the consumed meal.

8. The smart feeding apparatus of claim 1, wherein the control unit is further configured to feed the meal based on a time period input from the feeding apparatus or a feeder terminal.

9. The smart feeding apparatus of claim 1, further comprising a memory for storing a first voice and a second voice input via the feeding apparatus or the feeder terminal;
wherein the control unit is further configured to:
upon receiving the first input, output the first voice, and feed the meal; and
upon receiving the second input, output the second voice, and feed the snack.

10. The smart feeding apparatus of claim 1, wherein the first input is an input from a first button provided at the feeding apparatus or is a first signal received from a feeder terminal, and
wherein the second input is an input from a second button provided at the feeding apparatus or is a second signal received from the feeder terminal.

11. The smart feeding apparatus of claim 1, further comprising a subject-body temperature measurement sensor installed on an outer face of the body of the smart feeding apparatus,
wherein the control unit is further configured to:
provide, to a feeder terminal, information on a body temperature of a subject to be fed measured by the subject-body temperature measurement sensor; and
when the body temperature of the subject to be fed deviates from a predetermined range, transmit a warning message to the feeder terminal.

12. The smart feeding apparatus of claim 6, further comprising an information providing unit, wherein when a type of a subject to be fed input from a feeder terminal is a pet, the information providing unit is configured to match a breed, sex, or age of the corresponding pet to data pre-stored in a memory or a server, and to provide information on a meal or snack matching with the pet,
wherein the control unit is configured to analyze a type of the meal received in the container input from the feeder terminal, and the breed, the sex, and the age of the pet of the feeder, and adjust an amount of the meal to be supplied to the meal bowl based on the analysis result.
